(19) United States
(12) Patent Application Publication
(10) Pub. No.: US 2011/0024705 A1
(43) Pub. Date: Feb. 3, 2011

(54) Service jack with locking mechanism

(75) Inventors: Robert Fox, Greenville, SC (US); Wu Sheng Hua, Zhejiang (CN)

Correspondence Address: J. Bennett Mullinax;J. Bennett Mullinax, LLC, P O Box 26029, Greenville, SC, 29616-1029, US

(73) Assignees: International Specialty Services, Inc., Travelers Rest, SC (US); Hangzhou Harvest Machinery Manufacturing Co., Ltd., Zhejiang (CN)

(21) Appl. No.: 12/658,406

(22) Filed: Feb. 10, 2010

(30) Foreign Application Priority Data
Jul. 30, 2009 (CN) 200920189956.5

(51) Int. Cl. B66F 5/04; B66F 3/30

(52) U.S. Cl. 254/2 B; 254/93 H

(57) ABSTRACT

A service jack is provided that includes a base and a pump handle configured to pivot therewith. A lifting arm is in communication with the pump handle and can move with respect to the base. A locking mechanism is configured for limiting movement of the lifting arm with respect to the base when in a locked configuration. The locking mechanism has a locking handle that may be carried by the pump handle that is capable of being actuated between the locked configuration and an unlocked configuration.

### RELATED APPLICATIONS

This application claims the benefit of Chinese Application No. 200920189956.5, filed Jul. 30, 2009 and which is incorporated herein by reference.

### FIELD OF THE INVENTION

The present invention relates generally to a service jack that can be utilized when servicing a vehicle or other item that requires lifting. More particularly, the present application involves a service jack with a locking mechanism that allows the service jack to be used to not only lift the vehicle but also as a means to adequately support the vehicle.

### BACKGROUND

Objects, such as vehicles, are commonly lifted by the use of service jacks that are actuated when a user pumps a pump handle to cause hydraulic forces to be exerted onto a lifting arm that in turn engages and raises the object. Once lifted, the object to be supported is secured in the raised position through the use of jack stands or other mechanical support structure. The service jack itself is not used as a means for adequate support because the lifting arm may creep downwards over time or the hydraulic components of the service jack may fail at any time. However, at times it may be necessary for the user to place a portion of his or her body under the object being lifted in order to properly position and secure the jacks stands or other mechanical support structures. During these moments, the object is supported solely by the service jack that is susceptible to the possibility of failure.

Service jacks have been provided to function not only as a lifting device, but also as a means of support once lifted. In this regard, some service jacks include a series of apertures on the side of the lifting arm. Once the lifting arm raises the object to a desired position, the user may insert a safety pin through the aperture. If the hydraulic system of the service jack fails, the lifting arm will fall until a point at which the safety pin engages a side wall of a base of the service arm. This engagement will prevent the lifting arm from falling and hence function to hold the object in a raised position. Although providing a back up means of support, such service jacks require that the user extend a portion of his or her body under the object once raised to both engage and disengage the safety pin so that the lifting arm can be held and then lowered. Current service jacks require some portion of the user be located under the object after lifting the object thus subjecting the user to possibly injury. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of a service jack with a lifting arm oriented into a raised position in accordance with one exemplary embodiment.

FIG. 2 is a perspective view of the service jack of FIG. 1 in which a locking mechanism is oriented into a locked configuration.

FIG. 3 is a front view of the service jack of FIG. 1.

FIG. 4 is a front view of the service jack of FIG. 2.

FIG. 5 is a top view of the service jack of FIG. 1 in which the lifting arm is oriented into a lowered position.

FIG. 6 is a side view of the service jack of FIG. 1 with the lifting arm oriented into the lowered position.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a service jack 10 that includes a locking mechanism 18 that can be used to retain a raised lifting arm 16 in a raised position. The locking mechanism 18 may be activated and deactivated by use of a locking handle 20 that is located on a pump handle 14 of the service jack 10. In use, the user may raise the lifting arm 16 in a conventional manner through actuation of the pump handle 14 to a desired position. The user may then actuate the locking mechanism 18 through use of the locking handle 20 to prevent the lifting arm 16 from lowering without having to place any portion of his or her body under the object being lifted.

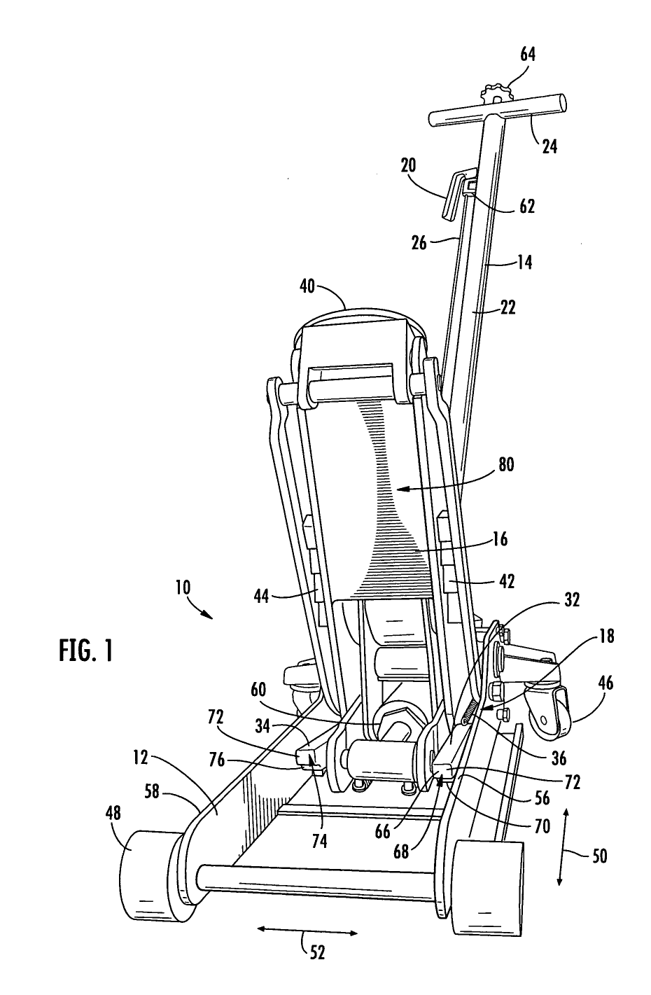

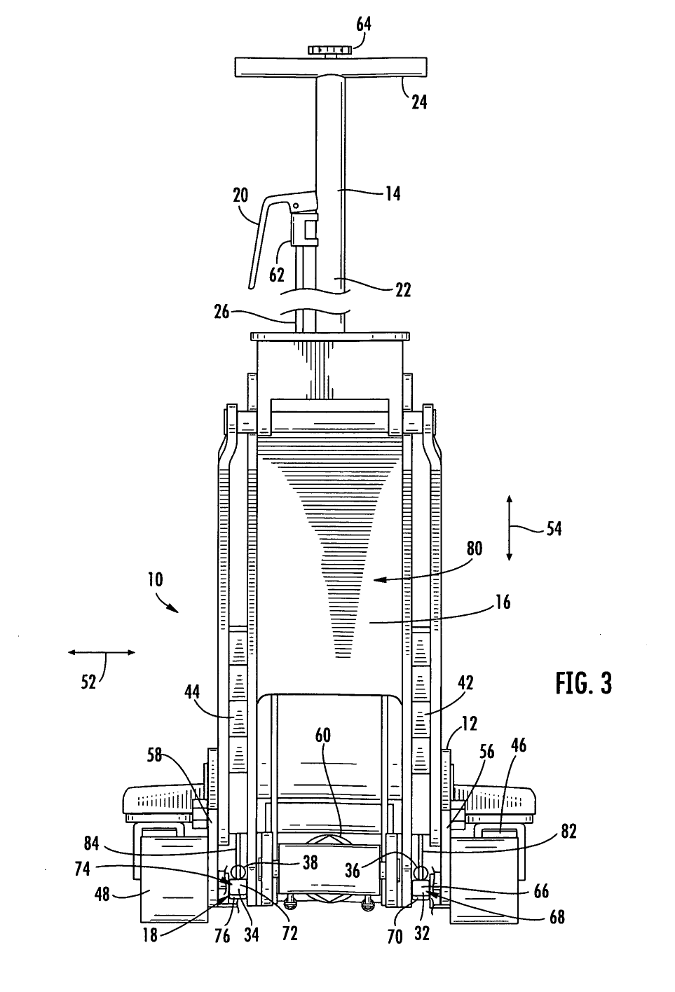

One exemplary embodiment of the service jack 10 is shown in FIGS. 1 and 3 in which the lifting arm 16 is oriented into a raised position. A locking mechanism 18 is included and is in an unlocked configuration. The service jack 10 includes a base 12 that has a first side wall 56 that is spaced from a second side wall 58 in a lateral direction 52 of the base 12. Certain portions of the locking mechanism 18 may be located between the side walls 56 and 58 when in the unlocked configuration. As shown, a first pawl 32 is pivotally mounted to the first side wall 56. Any type of connection may be employed to allow the first pawl 32 to pivot with respect to the base 12. In accordance with one embodiment, a stationary pin may extend from the first side wall 56 and the first pawl 32 may have a bearing or bushing connection therewith to effect the pivoting engagement. When the first pawl 32 is in the unlocked configuration, the lifting arm 16 may be lowered so that the first pawl 32 is located between the first side wall 56 and a portion of the lifting arm 16 in the lateral direction 52.

A first spring 36 is connected to the first pawl 32 and extends generally in the longitudinal direction 50 of the base 12. A clip (not shown) can be used to effect the connection between the first spring 36 and the first pawl 32. The first spring 36 may be an elongated coil spring in accordance with one exemplary embodiment. The point of attachment of the first spring 36 to the first pawl 32 may be located at a position that is longitudinally forward of the pivot connection of the first pawl 32 to the base 12. Also, the point of attachment of the first spring 36 may be located at a point that is vertically above the pivot connection of the first pawl 32. Force applied onto the first spring 36 will act to pivot the first pawl 32 about its pivot connection to the base 12. The first pawl 32 can include a spring attachment that is rigidly attached to the first pawl 32 and onto which the first spring 36 is attached. The first spring 36 may be biased to cause the first pawl 32 to be urged towards the unlocked configuration and hence the position illustrated in FIGS. 1 and 3.

The first pawl 32 has an end 66 that may be located remote from the end proximate to the pivot connection to the base 12. The end 66 may have an end surface 68 that can be rectangular in accordance with one exemplary embodiment. The end 66 may also have a step portion 70 that may likewise have a rectangular shape in other exemplary embodiments. The step portion 70 is recessed into the end 66 of the first pawl 32 so that the step portion 70 is lower in the vertical direction 54 than the end surface 68 when the first pawl 32 is oriented into the unlocked configuration as shown.

The locking mechanism 18 may also include a second pawl 34 that can be arranged in a manner similar to the first pawl 32. The second pawl 34 may be pivotally mounted onto the second side wall 58 and when in an unlocked configuration may be positioned between the second side wall 58 and a portion of the lifting arm 16 in the lateral direction 52 when the lifting arm 16 is oriented into the lowered position. As such, both the first pawl 32 and the second pawl 34 can be located between the first and second side walls 56 and 58 in the lateral direction 52 when the locking mechanism is in the unlocked configuration.

The second pawl 34 may have an end 72 that is located remote from the end of the second pawl 34 that is proximate the pivot connection to the base 12. The end 72 may be arranged in a manner similar to that of the end 66 discussed above in that it may include an end surface 74 and a step portion 76. Likewise, a second spring 38 is connected to the second pawl 34 and when force is applied thereto functions to pivot the second pawl 34 into the locked configuration. The second pawl 34 and second spring 38 may be arranged and function in a manner similar to that of the first pawl 32 and first spring 36 discussed above and a repeat of this information is not necessary. The first and second pawls 32 and 34 may be arranged with respect to one another so that they both pivot the same amount as one another all times. In other arrangements, the first pawl 32 may pivot a greater or lesser amount than the second pawl 34 when the locking mechanism 18 is actuated. The first and second pawls 32 and 34 may be sized and shaped in an identical manner to one another or may be sized and/or shaped differently from one another in various embodiments.

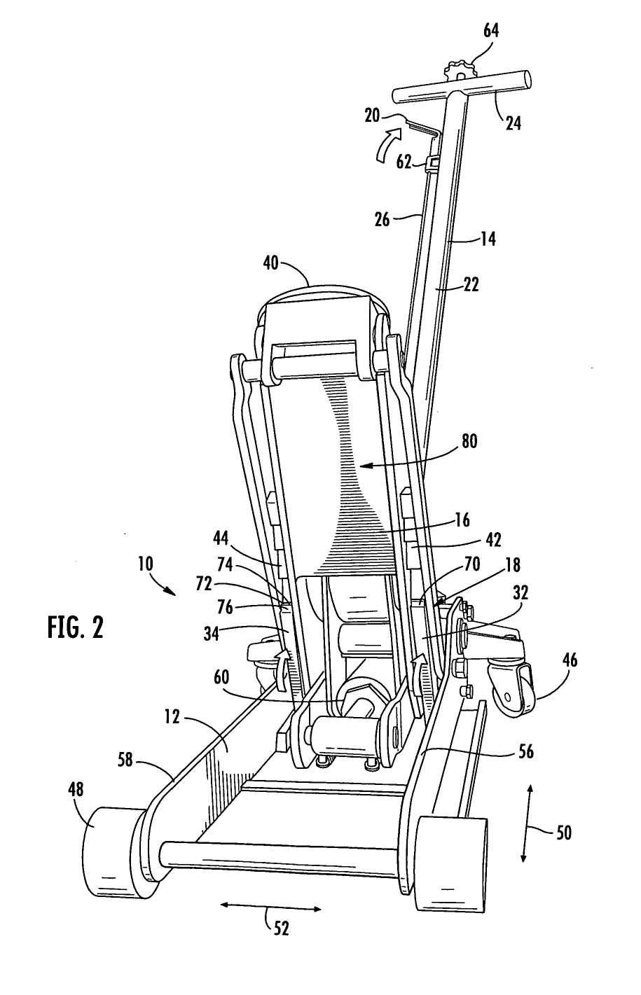

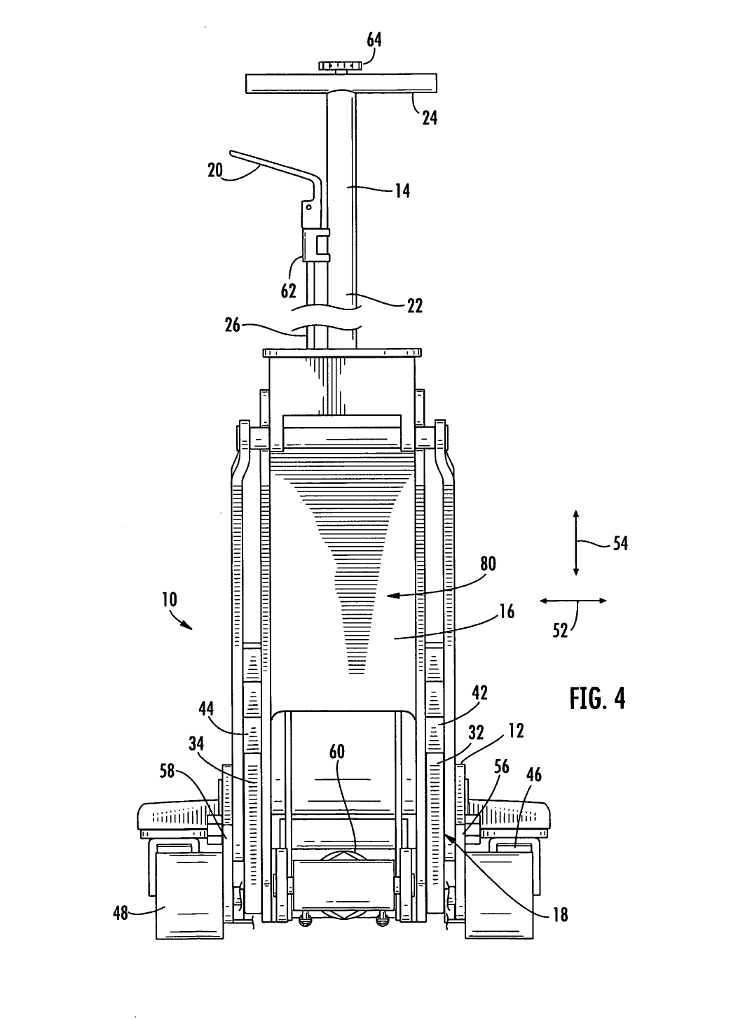

Placement of the locking mechanism 18 into the locked configuration will cause forces to be applied by the first and second springs 36 and 38 that will cause the first and second pawls 32 and 34 to pivot into the locked configuration shown in FIGS. 2 and 4. A lower surface 80 of the lifting arm 16 includes a first set of locking teeth 42 and a second set of locking teeth 44. The first pawl 32 engages the first set of locking teeth 42, and the second pawl 34 engages the second set of locking teeth 44. The first and second sets of locking teeth 42 and 44 may have a shape that is complimentary to that of the ends 66 and 72 of the pawls 32 and 34. In this regard, the shape of the first and second sets of locking teeth 42 and 44 may have a portion that receives the end surfaces 68 and 74 and a ridge or projection that is located within the step portions 70 and 76. In other embodiments, the locking teeth 42 and 44 need not have shapes that are complimentary to that of the shapes of the ends 66 and 72.

Engagement of the first and second pawls 32 and 34 with the first and second sets of locking teeth 42 and 44 prevents the lifting arm 16 from being lowered from the illustrated position. The locked position of the locking mechanism 18 thus prevents the lifting arm 16 from being lowered with respect to the base 12 in the event of hydraulic failure of a hydraulic cylinder 60 utilized to raise, lower, and hold the lifting arm 16 into a desired position.

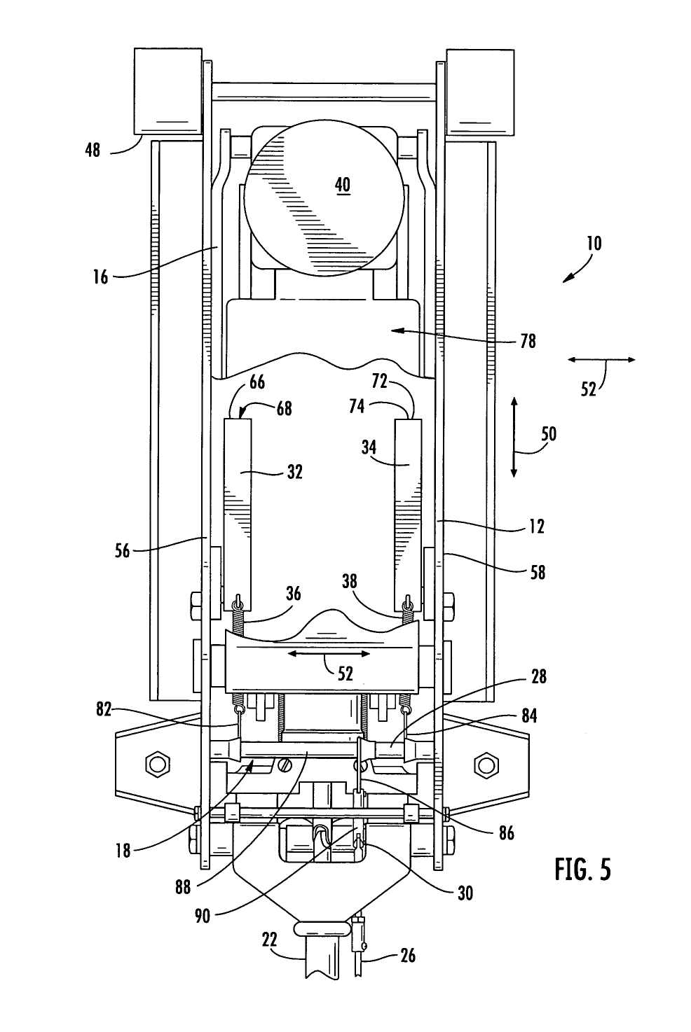

A top view of the service jack 10 is shown in a lowered position in FIG. 5. The locking mechanism 18 includes a crank assembly 28 that has a main body 88 that is cylindrical in shape. The main body 88 may be hollow or may be a solid piece in accordance with certain exemplary embodiments. The main body 88 may be pivotally mounted to the base 12 so that the crank assembly 28 can pivot with respect to the base 12. A pair of screws or spindles may extend from the first and second side walls 56 and 58 onto which the main body 88 may be mounted. Alternatively, an axle may be disposed through the main body 88 in order to pivotally mount the main body 88 to the base 12. Other mechanisms of rendering the main body 88 pivotal with respect to the base 12 can be employed in other embodiments. Flanges 82 and 84 are rigidly attached to the main body 88 and extend therefrom. Flange 82 may be connected to the first spring 36, and flange 84 may be connected to the second spring 38. Flanges 82 and 84 can extend from the same radial arc length of the main body 88 and may be parallel to one another. A third flange 86 may extend from the main body 88 and can be rigidly attached thereto. Flange 86 may extend at a different radial arc length than flanges 82 and 84. A locking rod 26 may be attached to a connecting strap 90 by way of a hinge 30. The connecting strap 90 can be attached to the flange 86 and this connection may be pivotal in some arrangements. The locking rod 26 can pivot with respect to the flange 86 due to the hinge 30 connection and the pivot connection between the connecting strap 90 and the flange 86. It is to be understood, however, that other arrangements are possible in which a hinge 30 connection is not employed between the locking rod 26 and the crank assembly 28, and in which the pivoting connecting strap 90 is likewise not used.

Movement of the locking rod 26 will cause movement of the flange 86 that will be a pivoting movement about the pivot connection between the body 12 and the crank assembly 28. The locking rod 26 may be moved upwards in the vertical direction 54 to effect this movement. As all portions of the crank assembly 28 are rigidly attached to one another, the main body 88 will pivot the same amount as the attached flanges 82, 84 and 86. The pivoting of the crank assembly 28 due to movement of the locking rod 26 will then be transmitted to the attached first and second springs 36 and 38 to cause these members to move. Movement of the first and second springs 36 and 38 will be in the longitudinal direction 50 away from the first and second pawls 32 and 34. Movement of the first and second springs 36 and 38 will then cause the first and second pawls 32 and 34 to rotate as previously discussed. The release of forces on the locking rod 26 will remove forces acting on the first and second springs 36 and 38 that will cause these two components to move into their biased position thus pivoting the first and second pawls 32 and 34 back into the unlocked position. In this regard the first and second springs 36 and 38 can have enough spring force to effect the movement, or downward movement of the locking rod 26 will cause the crank assembly 28 to rotate thus pushing the first and second springs 36 and 38 forward and releasing pressure thereon to cause the first and second pawls 32 and 34 to rotate into the unlocked position. In other embodiments, a combination of these two forces may be at work to effect movement of the locking mechanism to the unlocked position.

The pump handle 14 may be pivoted by the user in order to actuate the hydraulic cylinder 60 that in turn acts on the lifting arm 16 to cause the lifting arm 16 to be pivoted with respect to the base 12 so that a saddle 40 of the lifting arm 16 is raised or lowered. The pump handle 14 is shown in FIGS. 1 and 3 as having an elongated stem 22 with a handle 24 located at one end thereof. A locking handle mount 62 is rigidly attached to the elongated stem 22. A portion of the locking rod 26 is disposed through the locking handle mount 62 and can move relative to the locking handle mount 62. A locking handle 20 is pivotally mounted to the locking rod 26 and engages the top surface of the locking handle mount 62. As shown in FIGS. 1 and 3, the locking handle 20 is in the unlocked position so that the lifting arm 16 can be raised and lowered as desired. The unlocked position does not cause the locking rod 26 to exert force onto the crank assembly 28 and the first and second pawls 32 and 34 so that these components remain in the unlocked configuration.

The user may grasp the locking handle 20 and manually pull the locking handle 20 upwards and away from the elongated stem 22. Pulling of the locking handle 20 causes the base of the locking handle 20 to rotate about the top of the locking handle mount 62 so that the pivot connection between the locking handle 20 and the locking rod 26 is moved upwards into the position as shown in FIGS. 2 and 4. Continued rotation of the locking handle 20 by the user will eventually move the locking rod 26 to a raised position in which the base of the locking handle 20 is pressed against the top of the locking handle mount 62, and in which the side of the locking handle 20 is pressed against or close to the side of the elongated stem 22. The locking handle 20 is thus oriented into a locked position so that the locking rod 26 is moved upwards to cause the first and second pawls 32 and 34 to be pivoted upwards to effect engagement with the locking teeth 42 and 44 to prevent the lifting arm 16 from lowering. The pawls 32 and 34 are locked within the locking teeth 42 and 44 and actuation of the locking handle 20 will not function to cause the pawls 32 and 34 to disengage the locking teeth 42 and 44. If the lifting arm 16 is then raised so that the pawls 32 and 34 are not locked within the locking teeth 42 and 44, spring forces of the first and second springs 36 and 38 will be transmitted to the locking rod 26 to pull the locking rod 26 and attached locking handle 20 downwards back into the unlocked position shown in FIGS. 1 and 3. The user may thus actuate the locking mechanism 18 at a location carried by the pump handle 14 without having to reach down to the base 12 or under the object that is being lifted by the service jack 10. Although shown as having a particular configuration, it is to be understood that the locking handle 20 can be variously arranged in other exemplary embodiments in order to cause the locking mechanism 18 to be actuated.

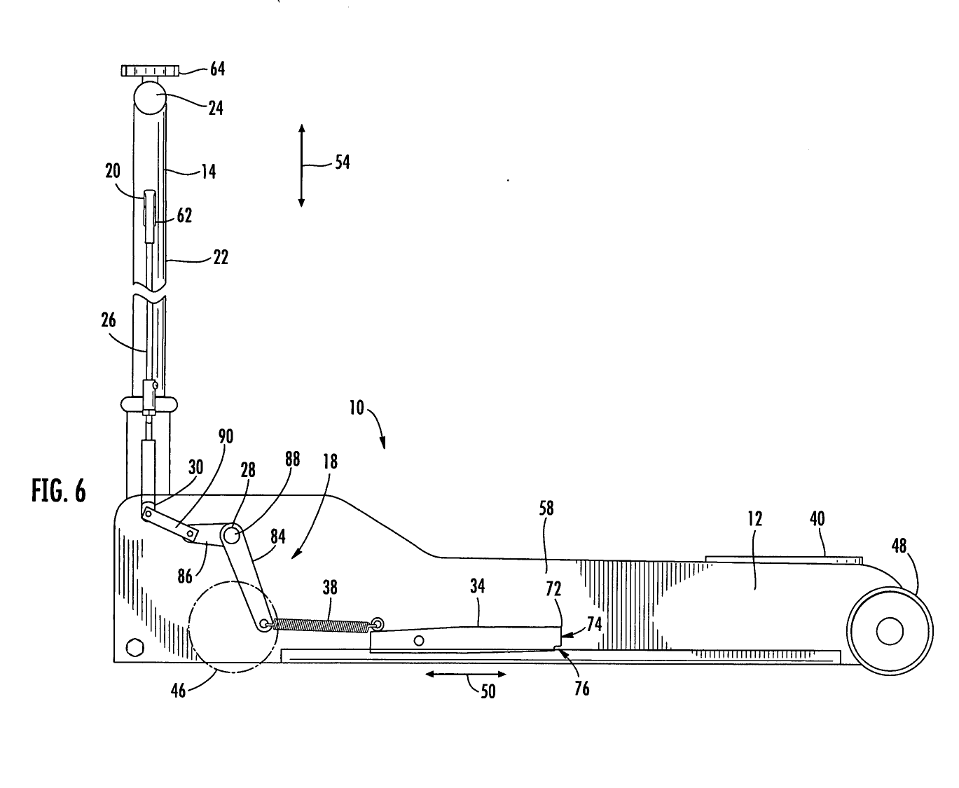

FIG. 6 is a side view of the service jack 10 with the lifting arm 16 in the lowered position. A first pair of wheels 46 is mounted to the base 12 and can swivel with respect to the base 12. The first pair of wheels 46 is located at a point in the longitudinal direction 50 that is within the longitudinal length of the locking mechanism 18. A second pair of wheels 48 are also mounted to the base 12 and are located at a point that is longitudinally beyond the locking mechanism 18 so that the second pair of wheels 48 is not located within the longitudinal length of the locking mechanism 18 in the longitudinal direction 50. The second pair of wheels 48 is rotationally mounted to the base 12 and does not swivel with respect to the base 12. However, it is to be understood that the first and second pairs of wheels 46 and 48 may swivel or not swivel with respect to the base 12 in other embodiments. The first and second pairs of wheels 46 and 48 rest on the surface onto which the service jack 10 is located.

The lifting arm 16 has a lower surface 80 onto which the first and second sets of locking teeth 42 and 44 are located. The lifting arm 16 also has an upper surface 78 that is located on an opposite side from the lower surface 80 in the vertical direction 54. The upper surface 78 includes a saddle 40 that is configured for engaging the object that is to be lifted. The service jack 10 with the included locking mechanism 18 can be constructed in a low profile manner so that the saddle 40 is low enough in the lowered position of the lifting arm 16 to be capable of being positioned under objects that have areas capable of engagement with the saddle 40 that are low to the surface. The distance in the vertical direction 54 from the surface onto which the service jack 10 rests to the upper surface of the saddle 40 may be 3.625 inches in accordance with one exemplary embodiment. The distance from the bottom of the first pair of wheels 46 and the bottom of the second pair of wheels 48 that contact the surface to the upper surface of the saddle 40 in the vertical direction 54 may be up to 3.625 inches in accordance with other exemplary embodiments. In still further versions of the service jack 10, the aforementioned distance in the vertical direction 54 may be up to 4 inches, up to 5 inches, up to 7 inches, up to 10 inches, up to 24 inches, from 1 to 2 inches, from 2 to 3 inches, or from 3 to 4 inches. Various features of the locking mechanism 18 allow for the low pick up height to be realized in the service jack 10. For example, the arrangement of components such as the locking handle 20, first pawl 32, second pawl 34, locking teeth 42, locking teeth 44, crank assembly 28, first spring 36, and/or second spring 38 may afford a low profile design of the service jack 10.

The service jack 10 provides a locking mechanism 18 that can be actuated in order to prevent the lifting arm 16 from being lowered without requiring the user place any part of his or her body under the object being lifted. In this regard, the locking handle 20 is carried by the pump handle 14 and is located remote from the bottom of the object being lifted so that it is not located under the object being lifted. The locking mechanism 18 thus adds an added measure of security to the operation of lifting an object as it may be actuated without having to place a body part under the object being lifted. However, it is to be understood that other support mechanisms, for example one or more vehicle support stands, need to be used in combination with the service jack 10 in certain circumstances in order to safely support and stabilize the object being lifted.

A user may operate the service jack 10 by rolling the service jack 10 under an object to be lifted so that the saddle 40 will be placed against a desired portion of the object to be lifted. The user may actuate the locking handle 20 to the locked position. A release valve knob 64 that can be located on the handle 24 of the pump handle 14 may be rotated in a clockwise direction until tight. Although not shown in the drawings, the pump handle 14 can be a hollow cylinder and a release shaft can be disposed in the hollow cylinder to effect communication between the release valve knob 64 and a release valve of the hydraulic cylinder 60. The release valve knob 64 is thus closed so that the hydraulic cylinder 60 can be actuated to raise the lifting arm 16. The user may grasp the handle 24 and pump the pump handle 16 up and down so that the saddle 40 of the lifting arm 16 engages the object to be lifted. Upon moving upwards, the first and second pawls 32 and 34 will slide over the first and second sets of locking teeth 42 and 44. The object may be lifted to a position slightly above the desired work height. Next, the user can rotate the release valve knob 64 in the counterclockwise direction to cause the hydraulic cylinder 60 to actuate so that the lifting arm 16 will be lowered to cause the first and second set of locking teeth 42 and 44 to engage the ends 66 and 72 of the first and second pawls 32 and 34 to prevent the lifting arm 16 from being lowered. In other arrangements, the object may be lifted to its desired work height and not above its desired work height at such time the pawls 32 and 34 will lock into the locking teeth 42 and 44. The user may then rotate the release valve knob 64 in the clockwise direction and tighten the release valve knob 64 so that the hydraulic cylinder 60 cannot be actuated to cause the lifting arm 16 to lower. As such, support is effected by the locked locking mechanism 18 and the hydraulic cylinder 60.

The user may lower the object being supported by pumping the pump handle 14 up and down to lift the lifting arm 16 above the locking mechanism's 18 locking height. Once the locked position of the locking mechanism 18 is cleared, the user may actuate the locking handle 20 to disengage the locking mechanism 18. As such, the first and second pawls 32 and 34 will be moved to their unlocked configuration. In other arrangements, the user need not pump the handle 14 so as to raise the lifting arm 16. Instead, the user may simply actuate the locking handle 20 to cause the pawls 32 and 34 to be urged out of engagement with the locking teeth 42 and 44. In either arrangement, the user may then rotate the release valve knob 64 in the counterclockwise direction slowly to release hydraulic pressure so that the lifting arm 16 is slowly lowered to its lowered position. In other arrangements, the user may keep the locking handle 20 in the unlocked position so that the locking mechanism 18 is not actuated and the service jack 10 can be used as a standard floor service jack through raising and lowering the lifting arm 16 in a conventional manner.

The various components of the locking mechanism such as the first and second pawls 32 and 34 and the crank assembly 28 can be integrated into the service jack 10 to maintain a low profile chassis and low saddle 40 pick up height. The size in the longitudinal direction 50, lateral direction 52, and vertical direction 54 of the base 12 may not be increased upon incorporation of the locking mechanism 18 as these components can be fit therein without added size or in some instances only minimal increases in size of the base 12. The locking rod 26 and locking handle 20 can be located on the pump handle 14 so that the overall size of the service jack 10 is not adversely affected. The locking mechanism 18 can be incorporated into variously configured service jacks. For example, service jacks including a pair of pump pistons in the hydraulic cylinder 40 may be used, or service jacks having but a single pump piston with the hydraulic cylinder 60 can be employed in other embodiments. The locking mechanism 18 may thus be employed with service jacks having a double pump piston equipped power supply or single pump piston equipped power supply with special fast lift and/or fast rise design features.

The service jack 10 may be used for both lifting and supporting the object and may thus be designed and subject to standards for both type of utility. In this regard, the service jack 10 may be designed to meet design qualification testing standards for both service jacks and for vehicle support stands. As such, the distance in the lateral direction 52 between the wheels of the first pair of wheels 46 may be greater than that of corresponding wheels of a service jack lacking the locking mechanism 18. Additionally or alternatively, the distance in the lateral direction 52 between the wheels of the second pair of wheels 48 may be greater than that of corresponding wheels of the service jack lacking the locking mechanism 18.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A service jack, comprising:
a base;
a pump handle configured for being pivoted with respect to the base;
a lifting arm in communication with the pump handle and configured for moving with respect to the base; and
a locking mechanism configured for limiting movement of the lifting arm with respect to the base when in a locked configuration, wherein the locking mechanism has a locking handle that is carried by the pump handle that is capable of being actuated between the locked configuration and an unlocked configuration.

2. The service jack as set forth in claim 1, wherein the pump handle has an elongated stem and a handle, wherein the locking handle is mounted to the elongated stem, wherein the orientation of the locking handle with respect to the elongated stem is capable of being changed in order to actuate the locking handle between the locked configuration and the unlocked configuration.

3. The service jack as set forth in claim 1, wherein the locking mechanism has a locking rod that extends from the locking handle, wherein the locking mechanism has a crank assembly that is pivotally mounted to the base, wherein the locking rod is connected to the crank assembly by way of a hinge and a strap, and wherein actuation of the locking handle causes movement of the locking rod that in turn causes pivotal movement of the crank assembly with respect to the base.

4. The service jack as set forth in claim 1, wherein the locking mechanism has a first pawl that is in pivotally mounted to the base, wherein the locking mechanism has a second pawl that is pivotally mounted to the base, wherein the locking mechanism has a first spring that engages the first pawl, wherein the locking mechanism has a second spring that engages the second pawl, wherein the first pawl and second pawl pivot with respect to the base upon actuating the locking mechanism from the unlocked configuration to the locked configuration.

5. The service jack as set forth in claim 4, wherein the lifting arm has a saddle and a first set of locking teeth and a second set of locking teeth, wherein the lifting arm is in pivotal engagement with the base such that the movement of the lifting arm with respect to the base is pivotal movement, wherein the first pawl engages the first set of locking teeth and the second pawl engages the second set of locking teeth when the locking mechanism is in the locked configuration to prevent pivotal movement of the lifting arm that would cause the saddle to be lowered.

6. The service jack as set forth in claim 4, wherein the base has a pair of wheels and a lateral direction that extends in the axial direction of the pair of wheels, wherein the base has a first side wall and a second side wall that are both located between the pair of wheels in the lateral direction, wherein the lifting arm is capable of being oriented into a raised position and a lowered position, wherein when the lifting arm is oriented into the lowered position the first pawl is located between the first side wall and the lifting arm in the lateral direction, and wherein when the lifting arm is oriented into the lowered position the second pawl is located between the second side wall and the lifting arm in the lateral direction.

7. The service jack as set forth in claim 1, further comprising a hydraulic cylinder in communication with the pump handle and the lifting arm such that pivoting of the pump handle causes a rod of the hydraulic cylinder to move to cause movement of the lifting arm with respect to the base.

8. The service jack as set forth in claim 1, wherein the locking mechanism has a locking handle mount that is rigidly attached to the pump handle, wherein the locking handle is pivotally attached to the locking handle mount, wherein the pump handle has a release valve knob that is capable of being actuated in order to release hydraulic pressure.

9. A service jack, comprising:
a base;
a lifting arm pivotally mounted to the base, wherein the lifting arm has a first set of locking teeth, wherein the lifting arm is capable of being oriented into a raised position and a lowered position; and
a first pawl pivotally mounted to the base, wherein the first pawl is capable of engaging the first set of locking teeth to prevent the lifting arm from being oriented to the lowered position.

10. The service jack as set forth in claim 9, further comprising:
a second pawl pivotally mounted to the base, wherein the lifting arm has a second set of locking teeth, wherein the second pawl is capable of engaging the second set of locking teeth to prevent the lifting arm from being oriented to the lowered position at the same time the first pawl engages the first set of locking teeth; and
a pair of wheels that are pivotally mounted to the base, wherein the base has a lateral direction that extends in the axial direction of the pair of wheels;
wherein the base has a first side wall and a second side wall that are both located between the pair of wheels in the lateral direction, wherein when the lifting arm is oriented into the lowered position the first pawl is located between the first side wall and the lifting arm in the lateral direction, and wherein when the lifting arm is oriented into the lowered position the second pawl is located between the second side wall and the lifting arm in the lateral direction.

11. The service jack as set forth in claim 9, wherein the first pawl has an end that has an end surface and a stepped portion, wherein the first set of locking teeth have a shape that is complimentary to the end of the first pawl so as to be capable of receiving the end surface and the stepped portion.

12. The service jack as set forth in claim 9, wherein the lifting arm has a saddle located on an upper surface, wherein the first set of locking teeth is located on a lower surface of the lifting arm, and wherein the upper surface of the lifting arm is opposite to the lower surface of the lifting arm.

13. The service jack as set forth in claim 9, wherein the first pawl is oriented to an unlocked configuration so that the lifting arm moves from the lowered position to the raised position and then back from the raised position to the lowered position without engagement between the first pawl and the first set of locking teeth.

14. The service jack as set forth in claim 9, further comprising:
a pump handle in pivotal engagement with the base; and
a locking handle capable of being actuated between a locked configuration and an unlocked configuration, wherein the locking handle is moved with respect to the base when the pump handle is pivoted with respect to the base.

15. A service jack as set forth in claim 14, wherein the pump handle has an elongated stem and a handle, wherein the locking handle is mounted to the elongated stem, wherein the locking handle is capable of pivoting with respect to the elongated stem between the unlocked configuration and the locked configuration, and wherein when the locking handle is in the locked configuration the first pawl is capable of engaging the first set of locking teeth to prevent the lifting arm from being oriented to the lowered position.

16. The service jack as set forth in claim 14, further comprising a locking handle mount that is rigidly attached to the pump handle, wherein the locking handle is pivotally attached to the locking handle mount, wherein the pump handle has a release valve knob that is capable of being actuated in order to release hydraulic pressure.

17. The service jack as set forth in claim 14, further comprising a hydraulic cylinder in communication with the pump handle and the lifting arm such that pivoting of the pump handle causes a rod of the hydraulic cylinder to move to cause pivoting of the lifting arm with respect to the base.

18. The service jack as set forth in claim 9, wherein the lifting arm has a saddle, and further comprising a pair of wheels attached to the base, wherein the distance in the vertical direction between a floor contacting portion of the pair of wheels and an upper surface of the saddle is not greater than 3.625 inches.

19. The service jack as set forth in claim 9, further comprising:
a first spring that engages the first pawl;
a crank assembly that is pivotally mounted to the base, wherein the first spring engages the crank assembly, wherein pivoting of the crank assembly with respect to the base causes the first spring to be elongated to cause the first pawl to be pivoted with respect to the base; and
a locking rod that that is in pivotal engagement with the crank assembly through the use of a connecting strap, wherein movement of the locking rod causes the crank assembly to be pivoted with respect to the base.

20. A service jack, comprising:
a base, wherein said base has a pair of wheels for use in rendering the base mobile on a surface;
a pump handle in pivoting engagement with the base;
a hydraulic cylinder that is actuated upon pivoting of the pump handle with respect to the base;
a lifting arm in communication with the hydraulic cylinder such that actuation of the hydraulic cylinder causes a saddle of the lifting arm to rise with respect to the base, wherein the lifting arm has a first set of locking teeth and a second set of locking teeth;
a first pawl pivotally mounted to the base;
a second pawl pivotally mounted to the base;
a first spring engaging the first pawl;
a second spring engaging the second pawl;
a crank assembly pivotally mounted to the base;
a connecting strap pivotally attached to the crank assembly;
a locking rod attached to the connecting strap by way of a hinge connection; and
a locking handle in communication with the locking rod, wherein the locking handle is carried by the pump handle and pivots with respect to the base when the pump handle pivots with respect to the base, wherein the locking handle is capable of pivoting with respect to the pump handle so as to be oriented between a locked configuration and an unlocked configuration, wherein when in the locked configuration the first pawl is capable of engaging the first set of locking teeth and the second pawl is capable of engaging the second set of locking teeth to prevent the lifting arm from moving from a raised position to a lowered position.
